(19) United States
(12) Patent Application Publication
(10) Pub. No.: US 2012/0066731 A1
(43) Pub. Date: Mar. 15, 2012

(54) CUSTOMER SERVICE CONTACT

(75) Inventors: Juan Vasquez, Gibsonton, FL (US); Prashant Desai, Land O Lakes, FL (US)

(73) Assignee: VERIZON PATENT AND LICENSING INC., Basking Ridge, NJ (US)

(21) Appl. No.: 12/881,615

(22) Filed: Sep. 14, 2010

(51) Int. Cl. G06F 15/16; H04N 7/173

(52) U.S. Cl. 725/106; 709/227; 725/109

(57) ABSTRACT

A method may include receiving, from a first user device, one or more session control protocol messages to establish a session between a workstation and a second user device, wherein the one or more session control protocol messages include context information indicating a context for establishing the session and an identifier of the second user device. The method may further include establishing a session between the network device and the second user device and displaying information indicating the context information on a display for an operator of the network device.

### BACKGROUND INFORMATION

Television viewers have access to an ever-growing amount and variety of content. For example, a viewer may choose between pay-per-view programs, on-demand programs, interactive games, music, broadcast television programs, etc. While selecting from this wide variety of content, the viewer may face issues (e.g., a technical problem or an issue with his account) for which he would like to speak to a customer service agent.

### BRIEF DESCRIPTION OF THE DRAWINGS

FIG. 1 is a diagram of an overview of an exemplary embodiment;

FIG. 2 is a diagram of an exemplary network for implementing different embodiments;

FIG. 3 is a block diagram of exemplary components of a computing module;

FIG. 4A is a block diagram of exemplary components of the set-top box or kiosk of FIG. 2;

FIG. 4B is a block diagram of exemplary components of the automatic call distributor (ACD) of FIG. 2;

FIG. 4C is a block diagram of exemplary components of one of the workstations of FIG. 2;

FIG. 5 is a flowchart of an exemplary process for establishing a call between a customer and a customer service agent;

FIG. 6 is a diagram of exemplary messages passed between devices in the network of FIGS. 2; and

FIG. 7 is a diagram of the display of the television of FIG. 1 in an exemplary embodiment.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

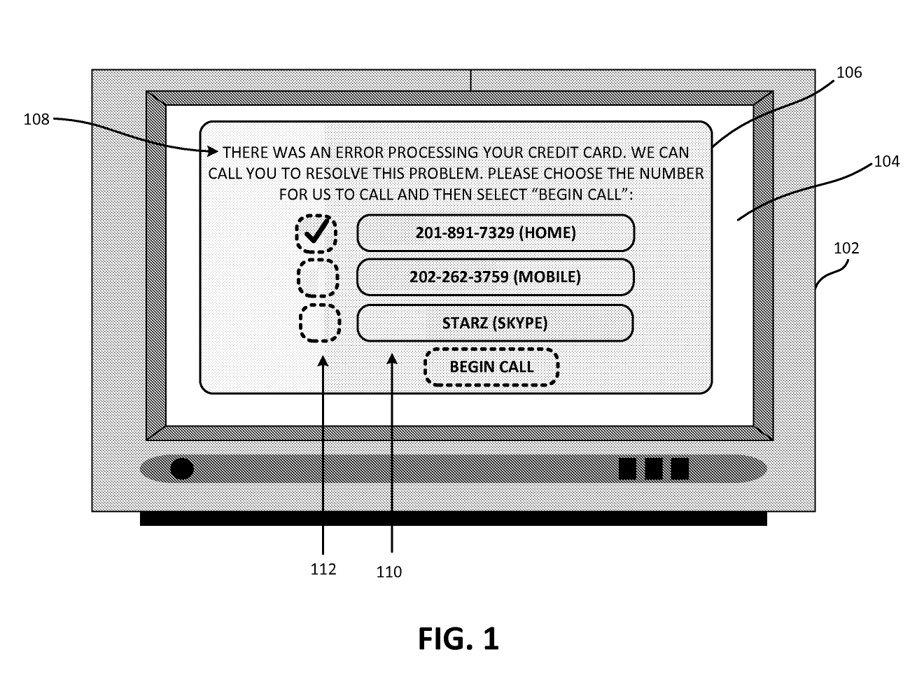

Embodiments disclosed herein may allow for a customer to establish a call with a customer service agent when the customer is experiencing an issue or problem. FIG. 1 is a diagram showing an example of one embodiment. FIG. 1 shows a TV 102 with a display 104 that is located in a customer's home. The customer attempted to purchase an on-demand video, but the transaction failed because of an issue with the customer's billing information. TV 102 displays an error message 108 in a dialog box 106 that indicates this issue to the customer. Dialog box 106 could display the telephone number of customer service for the customer to call to update his billing information. Instead, in this embodiment, dialog box 106 allows the customer to have a customer service agent call him. Dialog box 106 displays a list 110 of contact information associated with the customer, and the customer may use a remote control to select an entry in list 110 for a customer service agent to call. By selecting “BEGIN CALL,” a call is established between an appropriate customer service agent and the customer at the selected number. The term “customer” is used interchangeably with the term “user” in the description below. Further, the term “operator” is used interchangeably with the term “customer service agent.”

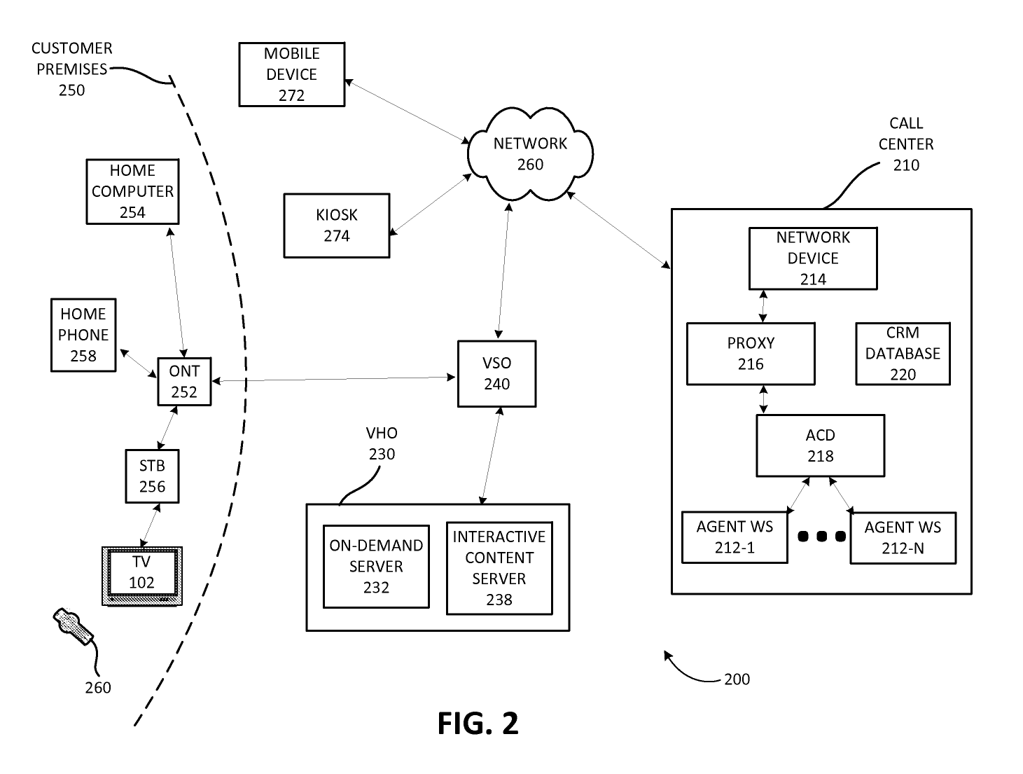

FIG. 2 is a diagram of an exemplary network 200 for implementing the embodiment of FIG. 1 and other embodiments. Network 200 may include a call center 210, a video hub office (VHO) 230, a video service office (VSO) 240, customer premises 250, a network 260, a mobile device 272, and a kiosk 274. Customer premises 250 (e.g., the customer's home) may include a TV 102, an optical network terminal (ONT) 252, a set-top box (STB) 256, a home computer 254, a home phone 258, and a remote control 260. Devices in customer premises 250, such as home computer 254, home phone 258, STB 256, remote control 260, and TV 102 may each be considered a “user device.”

ONT 252 may receive data, e.g., on a fiber optic cable, and may transfer the data to the appropriate device in customer premises 250, such as computer 254 or STB 256. Likewise, ONT 252 may receive data from any device in customer premises 250 and may transmit the data to other devices in network 200, e.g., through a fiber optic cable. ONT 252 may provide customer premises 250 with Internet access, television access, or telephone service, for example.

STB 256 may receive content and output the content to TV 102 for display. STB 256 may include a component (e.g., a cable card or a software application) that plugs into a host device (e.g., a personal computer, TV 102, a stereo system, etc.) that allows the host device to display content. STB 256 may also be implemented as a home theater personal computer (HTPC), an optical disk player (e.g., digital video disk (DVD) or Blu-Ray™ disc player), a cable card, etc. STB 256 may receive commands from other devices in network 200, such as remote control 260. In one embodiment, STB 256 may include a microphone and/or a camera.

TV 102 may include speakers as well as display 104. TV 102 may play content, for example, received from STB 256. While some embodiments described below may use TV 102, other embodiments may use any device (e.g., computer 254 or mobile phone 272).

Remote control 260 may issue wired or wireless commands for controlling other electronic devices, such as TV 102 or STB 256. Remote control 260, in conjunction with STB 256, may allow a user to interact with an application running on STB 256. Other types of devices (e.g., a keyboard, mouse, mobile phone, etc.) may be used instead of remote control 260.

Computer 254 may include a laptop, a desktop, a mobile telephone, a personal digital assistant (PDA), or another portable communication device. Computer 254 may include a microphone for capturing audio and/or a camera for capturing images or video. Computer 254 may also include a display for showing images or video or a speaker for playing audio.

Customer premises 250 may connect to VSO 240. VSO 240 may deliver content to customer premises 250 and may receive data from customer premises 250 for forwarding to the proper destination (e.g., call center 210). VSO 240 may include a content server for transcoding and multiplexing content from different sources for delivery to customer premises 250. VSO 240, VHO 230, call center 210, and other devices in network 200 may form part of a high-speed fiber optic network (e.g., FiOS™)

Mobile device 272 may include a radiotelephone, a personal communications system (PCS) terminal, a personal digital assistant (PDA), a laptop, or another portable communication device. mobile phone 220 may communicate with other devices via one or more communication towers (not shown) using a wireless communication protocol, e.g., GSM (Global System for Mobile Communications), CDMA (Code-Division Multiple Access), WCDMA (Wideband CDMA), IEEE 802.11x, etc. Mobile device 272 may be associated with a phone number, such as 202-262-3759 as shown in FIG. 1. Like the devices in customer premises 250, mobile device 272 may also be considered a “user device.”

Kiosk 274 may include one or more computers for hosting programs, such as a web browser, a database, or other applications. Kiosk 274 may include a display, a keyboard, a microphone, and a speaker. Kiosk 274 may include a handset with an integrated speaker and microphone. Kiosk 274 may be used, for example, as an automatic teller machine (ATM), a ticket machine, a calling card charging station, etc. Like the devices in customer premises 250, Kiosk 274 may also be considered a “user device.”

Call center 210 may include one or more servers (e.g., “network devices”) that manage and/or store information associated with providing customer service to customers. As shown in FIG. 2, call center 210 may include a network device 214, a proxy 216, an automatic call distributor (ACD) 218, a customer relations management (CRM) database 220, and agent workstations 212-1 through 212-N (collectively workstations 212, individually workstation 212-x).

Network device 214 may include one or more devices that allow different data networks to communicate and cooperatively carry traffic. For example, network device 214 may adapt between SS7 signaling and session initiation protocol (SIP) signaling, H.323 protocol signaling, or other protocol signaling used by other devices in network 200. In one implementation, network device 214 may convert time division multiplexed (TDM) encoded voice signals to packetized data suitable for transport to and processing by a proxy device, such as proxy 216. Network device 214 may include a gateway that provides for compatibility at two levels, e.g., between different signaling schemes and between different media forms.

Network device 214 may also include one or more session border controllers (SBCs) that provide control of the boundary between different service provider networks, provide signaling protocol compatibility between an IP-based network and other service provider networks, or control the transport boundary between service provider networks. In one embodiment, network device 214 may correspond to an ingress point to proxy 216.

Proxy 216 may provide signaling services to establish sessions between devices, such as home phone 258 and a workstation 212-x. Proxy 216 may include a server or computer that is able to receive data from network device 214 and forward the received data to an appropriate device, such as ACD 218 using a session signaling protocol, such as SIP or H.323. Proxy 216 may also receive data from ACD 218 and forward the received data to other devices, such as network device 214, for example.

ACD 218 may distribute calls to one of workstations 212. ACD 218 is illustrated as external from proxy 216. In some implementations, ACD 218 may be part of proxy 216. ACD 218 may forward calls to one of workstations 212 according to an algorithm. The algorithm may be based on which of workstations 212 has an available customer service agent, the experience of the customer service agent, the type of call, the type of customer, the type of issue or problem the customer is experiencing, etc.

Workstation 212-x may include a workstation or computer for a customer service agent to use for handling calls from customers that may benefit from human intervention. Workstation 212-x may include a telephone, a camera, a microphone, a speaker, and/or a headset including a microphone and speaker. Workstation 212-x may also include a software-implemented telephone (e.g., a “soft” phone) or a hardware implemented telephone (e.g., a “hard” phone). Workstation 212-x may also include software or hardware for performing packet-based data transmission to transmit data such as voice, video, or text.

CRM database 220 may include information about customers. For example, CRM database 220 may include a database of customer names, account numbers, transactions, addresses, transaction history, billing information, etc. CRM database 220 may also include information about issues or problems the customer has had, for example, with services provided by a service provider. For example, the customer may have difficulty purchasing on-demand content from on-demand server 232. A description of the issue or problem, the steps the customer and customer service agent have taken to resolve the problem, and the resolution may be stored in CRM database 220.

VHO 230 may include an on-demand server 232 and an interactive content server 238. On-demand server 232 may provide on-demand content. Interactive content server 238 may serve and manage interactive content (e.g., a form of content with which a user can interact).

Network 260 may include one or more packet switched networks, such as an Internet protocol (IP) based network, a local area network (LAN), a wide area network (WAN), a personal area network (PAN), an intranet, the Internet, a cellular network, a fiber-optic network, or another type of network that is capable of transmitting data. Network 260 may include a circuit-switched network, such as a public-switched telephone network (PSTN) for providing telephone services for traditional telephones. Network 260, in conjunction with components in VSO 240, may allow devices at customer premises 250 (e.g., a computer or a set-top box) to connect to other devices also attached to network 260, such as third party web site servers (not shown) or other customers (not shown).

The exemplary configuration of devices in network 200 is illustrated for simplicity. Network 200 may include more devices, fewer devices, or a different configuration of devices than illustrated in FIG. 2. For example, network 200 may include thousands or millions of customer premises. In some embodiments, the functions performed by two or more devices may be performed by any one device. Likewise, in some embodiments, the functions performed by any one device may be performed by multiple devices. Further, the connections shown in FIG. 2 are exemplary. In other embodiments, additional connections that are not shown in FIG. 2 may exist between devices (e.g., each device may be connected to every other device). The connections in FIG. 2 may also be wireless or wired.

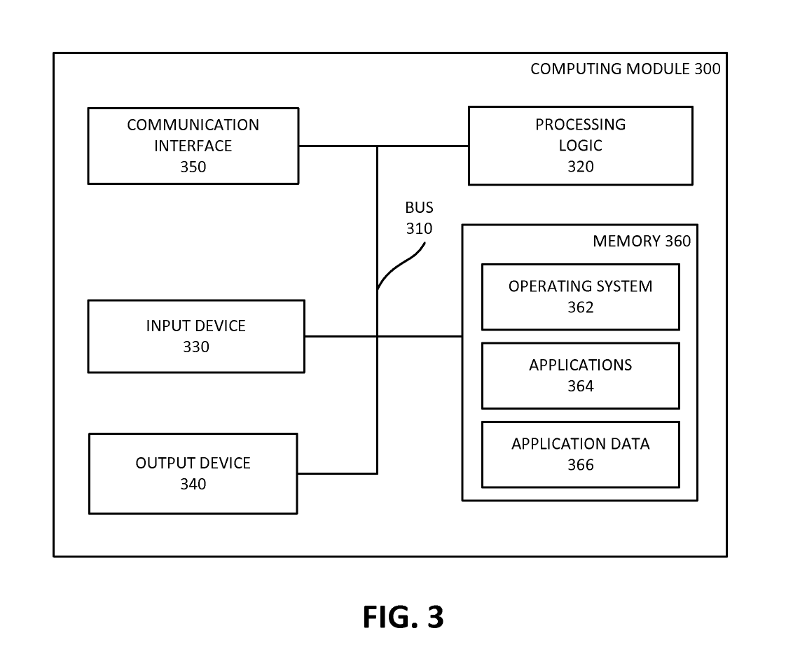

Devices in network 200 may each include one or more computing modules. FIG. 3 is a block diagram of exemplary components of a computing module 300. Computing module 300 may include a bus 310, processing logic 320, an input device 330, an output device 340, a communication interface 350, and a memory 360. Computing module 300 may include other components (not shown) that aid in receiving, transmitting, and/or processing data. Moreover, other configurations of components in computing module 300 are possible.

Bus 310 may include a path that permits communication among the components of computing module 300. Processing logic 320 may include any type of processor or microprocessor (or families of processors or microprocessors) that interprets and executes instructions. In other embodiments, processing logic 320 may include an application-specific integrated circuit (ASIC), a field-programmable gate array (FPGA), etc.

Input device 330 may allow a user to input information into computing module 300. Input device 330 may include a keyboard, a mouse, a pen, a microphone, a remote control (e.g., remote control 260), an audio capture device, an image and/or video capture device, a touch-screen display, etc. Some devices, such as servers 232, 238, and 216-220 may be managed remotely and may not include input device 330. In other words, some devices may be “headless” and may not include a keyboard, for example.

Output device 340 may output information to the user. Output device 340 may include a display, a printer, a speaker, etc. For example, TV 102 includes a display (an output device), which may include a liquid-crystal display (LCD) for displaying content to the user. As another example, ONT 252 and STB 256 may include light-emitting diodes (LEDs). Headless devices, such as servers 232, 238, and 216-220, may be managed remotely and may not include output device 340.

Input device 330 and output device 340 may allow a user to activate and interact with a particular service or application, such as an interactive application. Input device 330 and output device 340 may allow a user to receive and view a menu of options and select from the menu options. The menu may allow the user to select various functions or services associated with applications executed by computing module 300.

Communication interface 350 may include a transceiver that enables computing module 300 to communicate with other devices or systems. Communication interface 350 may include a transmitter that converts baseband signals to radio frequency (RF) signals or a receiver that converts RF signals to baseband signals. Communication interface 350 may be coupled to an antenna for transmitting and receiving RF signals. Communication interface 350 may include a network interface card, e.g., Ethernet card, for wired communications or a wireless network interface (e.g., a WiFi) card for wireless communications. Communication interface 350 may also include, for example, a universal serial bus (USB) port for communications over a cable, a Bluetooth™ wireless interface, a radio-frequency identification (RFID) interface, a near-field communications (NFC) wireless interface, etc.

Memory 360 may store, among other things, information and instructions (e.g., applications 364 and operating system 362) and data (e.g., application data 366) for use by processing logic 320. Memory 360 may include a random access memory (RAM) or another type of dynamic storage device, a read-only memory (ROM) device or another type of static storage device, and/or some other type of magnetic or optical recording medium and its corresponding drive (e.g., a hard disk drive).

Operating system 362 may include software instructions for managing hardware and software resources of computing module 300. For example, operating system 362 may include Linux, Windows, OS X, Android, an embedded operating system, etc. Applications 364 and application data 366 may provide network services or include applications, depending on the device in which the particular computing module 300 is found.

Computing module 300 may perform the operations described herein in response to processing logic 320 executing software instructions contained in a computer-readable medium, such as memory 360. A computer-readable medium include a physical or logical memory device. The software instructions may be read into memory 360 from another computer-readable medium or from another device via communication interface 350. The software instructions contained in memory 360 may cause processing logic 320 to perform processes that are described herein.

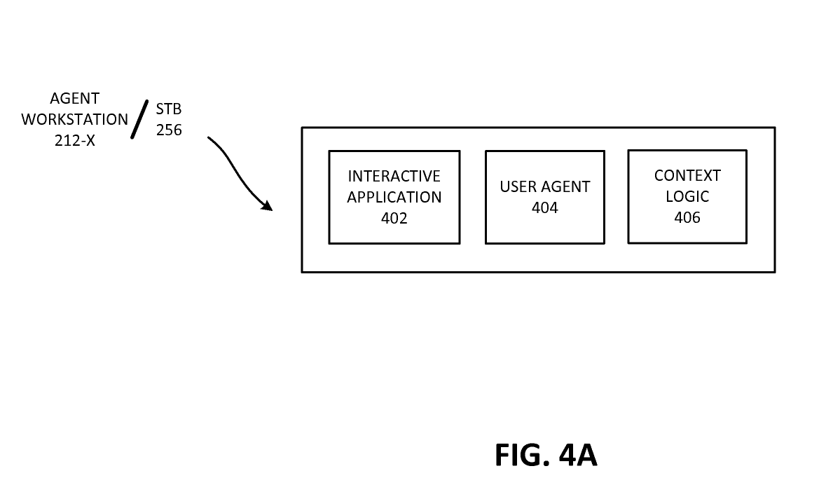

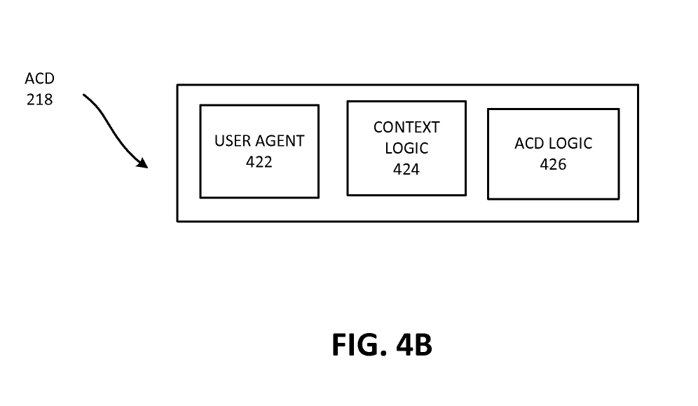

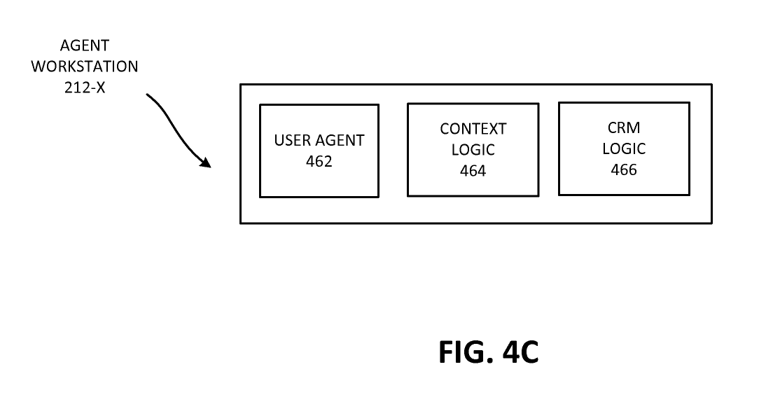

As described above, STB 256 may allow a user to establish a call with a customer service agent. FIG. 4A is a block diagram of exemplary components of STB 256 (e.g., functions performed by application 364 in processing logic 320 or stored in memory 360 of STB 256). STB 256 may include an interactive application 402, a user agent 404, and context logic 404. Kiosk 274 may be configured similarly to STB 256.

Interactive application 402 may include an application that allows the user to interact with STB 256 and/or TV 102. For example, application 402 may include an application to allow the user to browse on-demand content for purchase and viewing. Application 402 may include a web browser or a game. Use of application 402 may, for example, incur a charge on a customer's account.

User agent 404 may implement a session signaling protocol, such as SIP or H.323, for creating media or data sessions between network devices. As a SIP user agent, for example, user agent 404 may create or receive SIP messages to manage a SIP session. In one embodiment, user agent 404 may perform the role of a SIP client, which sends SIP requests, or a SIP server, which receives the requests and returns SIP responses.

Context logic 406 may determine the context (e.g., the context of a failed transaction) for transmitting to call center 210 when the user establishes a call with a customer service agent. Context logic 406 may interoperate with user agent 404 to insert the context data into a header of a session signaling protocol messages, such as a SIP message. The context data may include a transaction identifier (ID), a transaction history, a transaction name, a customer name, etc., associated with a failed transaction, for example.

As described above, ACD 218 may distribute calls established by a customer to one of a group of workstations and customer service agents. FIG. 4B is a block diagram of exemplary components of ACD 218 (e.g., functions performed by application 364 in processing logic 320 or stored in memory 360 of ACD 218). ACD 218 may include a user agent 422, context logic 426, and ACD logic 422. User agent 422 may receive, interpret, and respond to session signaling message, such as SIP messages. Context logic 424 may read session signaling messages to extract and interpret context data inserted, for example, into message headers by, for example, a user device such as STB 256. ACD logic 426 may forward session signaling messages to the appropriate workstation 212-x or assist in establishing a session between a user device (e.g., home phone 258) and one of workstations 212.

As described above, workstation 212-x may receive calls or place calls established by a customer. A customer service agent may sit at workstation 212-x, for example, to talk to a customer about resolving issues with an account or transaction. FIG. 4C is a block diagram of exemplary components of workstation 212-x (e.g., functions performed by application 364 in processing logic 320 or stored in memory 360 of workstation 212-x). Workstation 212-x may include a user agent 462, context logic 464, and CRM logic 466. User agent 462 may receive, interpret, and respond to session signaling messages, such as SIP messages. Context logic 464 may read session signaling messages to extract and interpret context data, for example, inserted into message headers by a user device such as STB 256. Context logic 464 may display context information to the customer service agent so that the customer service agent may better help the customer. CRM logic 466 may allow the customer service agent to access and update customer information stored in CRM database 220.

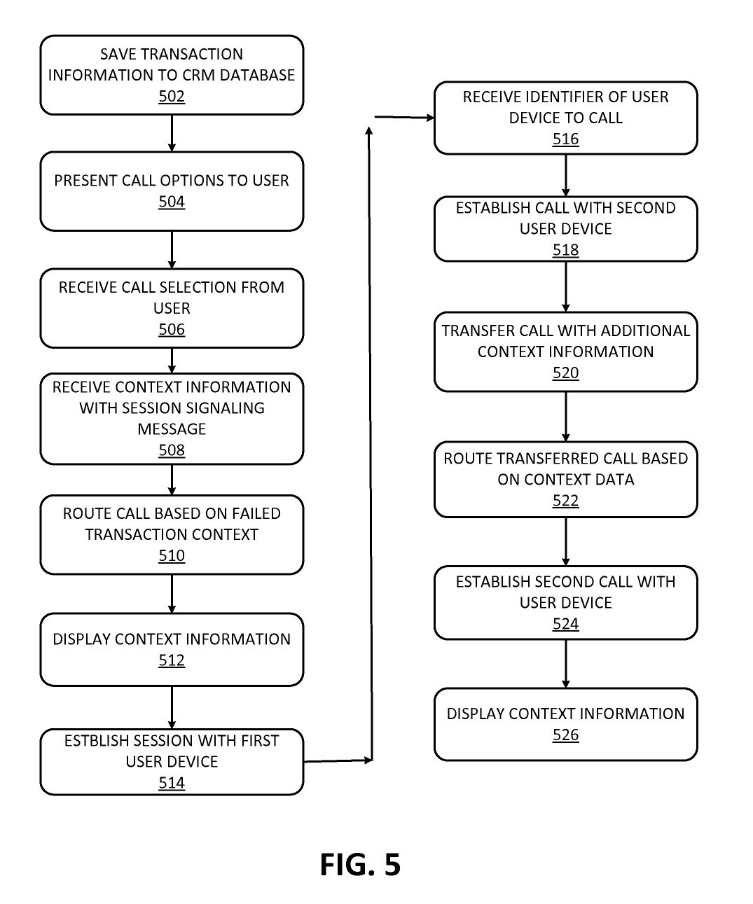

As described above, network 200 may allow for a user (e.g., customer) to establish a call with a customer service agent (e.g., operator). FIG. 5 is a flowchart of a process 500 for establishing a call between a customer service agent and a user. The following example assumes that the user is at home sitting in front of TV 102 interacting with TV 102 and/or STB 256 with remote control 260. Using application 402 running in STB 256, for example, the user attempts to purchase a movie from on-demand server 232. An error occurs because, for example, the user's billing information is not correct. Application 402 in STB 256 may instruct TV 102 to display error message 108, as shown in FIG. 1 and described above. In one embodiment, the failed transaction information may be saved to CRM database 220 (block 502) by, for example, application 402 running in STB 256. The transaction information may include the type of issue or problem, a description of the issue or problem, a transaction ID, the transaction history, a customer ID, etc. At a later time, a customer service agent at one of workstations 212, for example, may be able to access CRM database 220 to help the user with any issue or problem (e.g., receive new credit card information).

Rather than asking the user to call a customer service agent, in one embodiment, the user may be presented with options for a customer service agent to call him. Application 402 may receive list 110 of contact information from CRM database 220 for display on TV 102. The list 110 may include telephone numbers or other means of contacting the user (e.g., a universal resource indicator (URI), Skype™ username, etc.). List 110 (e.g., call options) may be presented to the user (block 504), as shown in FIG. 1. Application 402 may ask the user to select a call option (e.g., a number from list 110) on which a customer service agent will call the customer to resolve the issue/problem. In this example, the user may operate remote control 260 to mark his home number (e.g., 201-891-7329) in a selection field 112, as shown in FIG. 1. The selection for the call is received from the user (block 506) in, for example, STB 256.

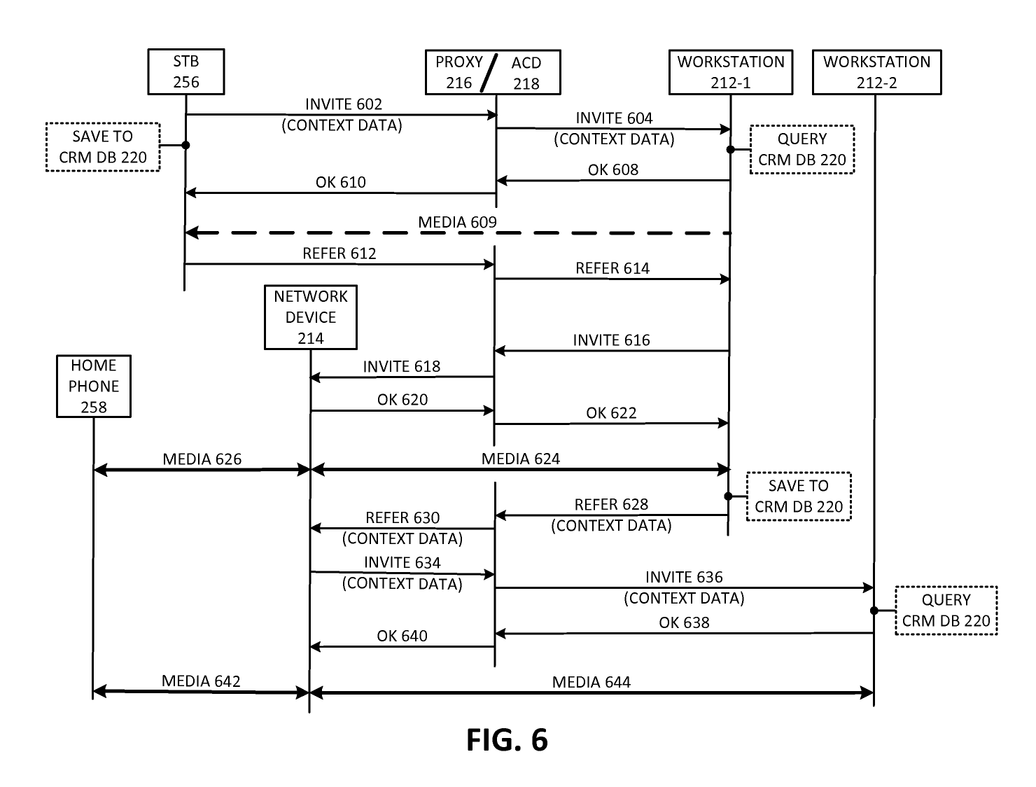

STB 256 may send a session signaling message, including context data, to call center 210 to establish a session with the selected user device. The session signaling message, including the context data, may be received (block 508) in call center 210. The session signaling message may include a SIP message, but other session signaling protocol messages are possible. The context data may include the context of the transaction (e.g., transaction ID, customer ID, transaction history, transaction type, description of problem or issue, etc.). For example, as shown in FIG. 6, STB 256 may send an INVITE message 602 to ACD 218. INVITE message 602 may include the context data in a header field. In one implementation, the context data may be formatted in an extensible-markup language (XML) format. In one embodiment, the session signaling message may also include an identifier of the device with which to establish the session (e.g., 201-891-7329 of home phone 258).

For ease of illustration, FIG. 6 shows ACD 218 and proxy 216 as one device. Proxy 216 and/or ACD 218, in one embodiment, may not include the software and/or hardware to interpret the context data stored in the header fields. In this case, proxy 216 and/or ACD 218 may handle INVITE message 602 by ignoring the context data. Proxy 216 and/or ACD 218 may nonetheless forward the context data in the header of INVITE message 604. Such an implementation may be consistent with the SIP standard, for example.

On the other hand, in another embodiment, ACD 218 may include context logic 424. In this embodiment, the session signaling message may be routed based on the context information (block 510). Context logic 424 may inspect the context data stored in the header and ACD logic 426 may use the context data to select one of workstations 212 to establish a call between a customer service agent and home phone 258. For example, ACD logic 426 may inspect the context data and determine that the problem involves improper billing information. As a result, ACD logic 426 may select workstation 212-1 with an agent having the appropriate experience to handle the call.

The session signaling message, including the context data, may be forwarded to the appropriate workstation. For example, ACD 218 selects workstation 212-1 and, as shown in FIG. 6, forwards INVITE message 604 to workstation 212-1. INVITE message 604 may include, in its header, the context data from INVITE message 602. In this example, a customer service agent at workstation 212-1 may pick up a ringing phone, and, as shown in FIG. 6, workstation 212-1 may respond with an OK message 608, which ACD 218 forwards as an OK message 610 to STB 256.

Context logic 464 in workstation 212-1 may inspect the context data stored in the header information of INVITE message 604. Context information may be displayed on a display (block 512) associated with workstation 212-1. For example, the agent at workstation 212-1 may be able to view the name, transaction ID, transaction history, etc., that may be indicated in the context data of INVITE message 604. In addition, workstation 212-1 may query CRM database 220 so that the agent has full access to the customer's information, not just the context data stored in INVITE message 604.

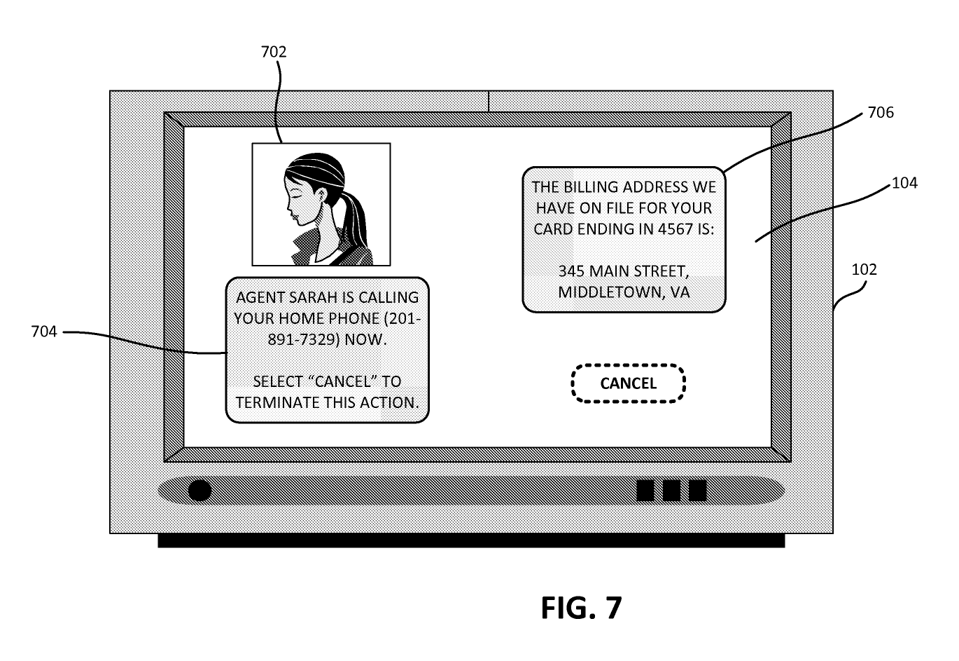

In one embodiment, a media session 609 may be established between workstation 212-1 and STB 256 (block 514) (e.g., a first user device). As shown in FIG. 7, for example, STB 256 may receive and TV 102 may display the image of the customer service agent calling the user. TV 102 may also display other information associated with the transaction, such a dialog box 704 indicating the status of the call to home phone 258 or a dialog box 706 indicating the current billing address associated with the user. In one embodiment, a video of the customer service agent may be displayed by TV 102. In another embodiment, audio from the customer service agent may be played from speakers associated with TV 102. Because, in one implementation, STB 256 and/or TV 102 does not include a microphone or a camera, media session 609 is shown as unidirectional (one-way or simplex) in the direction from call center 210 to STB 256. In an implementation in which STB 256 and/or TV 102 include a microphone or a camera, media session 609 may be bidirectional, duplex, or full duplex. In another embodiment, media session 609 is not established at all.

The session requested by the user however, is between call center 210 and home phone 258. Therefore, STB 256 may “transfer” or “refer” workstation 212-1 to home phone 258. STB 256 may send a REFER message 612 to ACD 218. REFER message 612 includes the identifier of the target of the media session (e.g., the telephone number of home phone 258). ACD 218 forwards REFER message 612 as REFER message 614 to workstation 212-1. Thus, the identifier of the user device to call is received (block 516) in call center 210.

As shown in FIG. 6, in response to REFER message 614, workstation 212-1 sends an INVITE message 616 to ACD 218, which forwards INVITE message 616 as INVITE message 618 to network device 214. As mentioned above, network device 214 may act as a proxy on behalf of home phone 258, which may not be a SIP compliant device, for example. Network device 214 responds with OK message 620 to ACD 218, which is forwarded as OK message 622 to workstation 212-1. Thus, a media session 624 may be established between network device 214 and workstation 212-1. Network device 214 may also establish a media session 626 to home phone 258 in the appropriate fashion, depending on the type of endpoint (e.g., home phone, cell phone, IP phone, etc.). Thus, the agent at workstation 212-1 and the user at home phone 258 can speak with each other to resolve any problems or issues. The agent may save the transaction history regarding the user in CRM database 220 for future reference.

If the agent at workstation 212-1 cannot resolve the issue, for example, then the agent can transfer the call to yet another customer service agent. In this case, workstation 212-1 may send a REFER message 628 to ACD 218. REFER message 628 may include the context data. The context data may include the same information as transmitted in INVITE message 604, for example. The context data may also include additional context data regarding the context of why the user's problem was not resolved in with the first customer service agent. In one embodiment, the context data and additional context data may be stored in the header of REFER message 628. In yet another embodiment, the context data may include a count of the number of times that the user has been transferred to another workstation. For example, the context data in messages 628, 630, 634, and 636 may include a count of “1” because it is the first time, in this example, that the user has been transferred.

ACD 218 may forward REFER message 628 to network device 214 as REFER message 630. REFER message 630 may also include context data. In one embodiment, ACD 218 ignores the context data and passes it from REFER message 628 to REFER message 630. For example, in one implementation, ACD 218 and/or proxy 216 may not include any context logic (e.g., context logic 424). Referring back to FIG. 6, network device 214 sends an INVITE message 634 to ACD 218. Network device 214 may copy the context data from REFER message 630 (e.g., in the header of REFER message 630) to INVITE message 634 and send INVITE message 634 to ACD 218. In this embodiment, network device 214 may copy the context data in the header of REFER message 630 to comply with the SIP standard.

On the other hand, in one embodiment, ACD includes context logic 424, as shown in FIG. 4B. In this embodiment, the call may be routed based on the context data and/or additional context data (block 522). For example, ACD 218 may select workstation 212-2 based on the context data or additional context data. Referring back to FIG. 6, ACD 218 forwards INVITE message 636 to workstation 212-1. INVITE message 636 may include, in its header, the context data from INVITE message 634. In this example, an agent at workstation 212-2 may pick up a ringing phone, and workstation 212-2 may respond with an OK message 638, which ACD 218 forwards as OK message 640 to network device 214. A media session 644 may be established between workstation 212-2 and network device 214. Network device 214 may connect media session 644 to media session 642 in the appropriate fashion. Thus, a second call is established with home phone 258 (e.g., the user device) and workstation 212-2 (block 524).

Context logic 464 in workstation 212-2 may inspect the context data and/or additional context data stored in the header information of INVITE message 636. The context may be displayed on a display (block 526) associated with workstation 212-2. For example, the agent at workstation 212-2 may display the name, transaction ID, transaction history, etc., that may be included in the context data in the header of INVITE message 636. In addition, workstation 212-2 may query CRM database 220 so that the agent has full access to the customer information.

After the user discusses his issues or problems with the customer service agent at workstation 212-2, the customer service agent may wish to transfer the user to yet another customer service agent. In this case, blocks 520-526 may be repeated many times. In this case, the count of the number of transfers may be increased from “1” to “2,” from “2” to “3,” etc. The decision to route the transferred call may be based on the count, as the count forms part of the context data.

While process 500 has been described with respect to STB 256 and TV 102, process 500 may also be implemented with respect to kiosk 274. For example, if a transaction has failed at a bank's ATM, a customer could initiate a call between the bank's customer service agent and the customer. Thus, the customer, standing in front of the ATM (e.g., kiosk 274), could receive a call on mobile phone 272. In one embodiment, if the kiosk 274 includes a microphone and a camera, the customer and the service agent could partake in a video conference (e.g., as part of media session 609).

While media sessions 624, 626, 642, and 644 are described above as including a full-duplex voice conversation between the user and the customer service agent, other types of media sessions are possible. The media sessions may also or alternatively include video sessions where the user and customer service agent can see each other. The media sessions may also be full or half duplex or simplex.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Further, certain portions of the invention may be implemented as logic that performs one or more functions. This logic may include hardware, such as an application specific integrated circuit, a field programmable gate array, a processor, or a microprocessor, or a combination of hardware and software.

No element, act, or instruction used in the description of the present application should be construed as critical or essential to the invention unless explicitly described as such. Also, as used herein, the articles “a” and the term “one of” are intended to include one or more items. Further, the phrase “based on” is intended to mean “based, at least in part, on” unless explicitly stated otherwise.

What is claimed is:

1. A computer-implemented method comprising:
receiving, from a first user device, one or more session control protocol messages to establish a session between a workstation and a second user device, wherein the one or more session control protocol messages include context information indicating a context for establishing the session and an identifier of the second user device;
establishing the session between the workstation and the second user device; and
displaying information indicating the context information on a display for an operator of the workstation.

2. The computer-implemented method of claim 1, wherein the first user device and the second user device are associated with a same user.

3. The computer-implemented method of claim 2, wherein first user device is a set-top box (STB) or a television and the second user device is a telephone.

4. The computer-implemented method of claim 1,
wherein the context information includes information indicating an unsuccessful financial transaction, or
wherein the context information includes a transaction history.

5. The computer-implemented method of claim 1, wherein establishing the session between the workstation and the second user device includes establishing, based on the context information, the session between one of a plurality of workstations and the second user device.

6. The computer-implemented method of claim 5, further comprising:
querying a database to determine the one of the plurality of workstations manned by an operator with requisite experience to handle the session, wherein the session includes a full-duplex audio voice session; and
selecting the one of the plurality of workstations based on the querying of the database.

7. The computer-implemented method of claim 1, further comprising:
establishing a second session between the workstation and the first user device, wherein the second session includes a unidirectional video session to the first user device.

8. The computer-implemented method of claim 7, wherein the second session includes a unidirectional audio voice session to the first user device.

9. The computer-implemented method of claim 1, wherein a first workstation includes the workstation, the method further comprising:
receiving, from the first workstation, one or more session control protocol messages to establish a third session between a second workstation and the second user device, wherein the one or more session control protocol messages include information indicating the context information and additional context information for establishing the third session.

10. The computer-implemented method of claim 9, wherein a plurality of workstations includes the first workstation and the second workstation, wherein the context information or the additional context information includes a count of the number of sessions established between any of the plurality of workstations and the second user device.

11. A computer-implemented method comprising:
receiving, from a first user device, one or more session control protocol messages to establish a session between one of a plurality of workstations and a second user device, wherein the one or more session control protocol messages include context information indicating a context for establishing the session and an identifier of the second user device; and
establishing, based on the context information, the session between the one of the plurality of workstations and the second user device.

12. The computer-implemented method of claim 11, further comprising:
querying a database to determine the one of the plurality of workstations manned by an operator with requisite experience to handle the session, wherein the session includes a full-duplex audio voice session; and
selecting the one of the plurality of workstations based on the querying of the database.

13. The computer-implemented method of claim 11, further comprising displaying information indicating the context information on a display for an operator of the workstation.

14. The computer-implemented method of claim 11, wherein the first user device and the second user device are associated with a same user.

15. The computer-implemented method of claim 14, wherein first user device is a set-top box (STB) or a television and the second user device is a telephone.

16. A system comprising:
a workstation comprising a display; and
a network device comprising:
a transceiver to receive, from a first user device, one or more session control protocol messages to establish a session between a workstation and a second user device, wherein the one or more session control protocol messages include context information indicating a context for establishing the session and an identifier of the second user device, and
a processor to establish the session between the workstation and the second user device;
wherein the display of the workstation displays the context information for an operator of to view.

17. The system of claim 16, further comprising the first user device, wherein the first user device and the second user device are associated with a same user.

18. The system of claim 17, wherein the first user device is a set-top box (STB) or a television and the second user device is a telephone.

19. The system of claim 16,
wherein the context information includes information indicating an unsuccessful financial transaction, or
wherein the context information includes a transaction history.

20. The system of claim 16, further comprising an automatic call distributor (ACD) having a processor, wherein the processor selects, based on the context information, one of a plurality of workstations for distributing the session between the selected workstation and the second user device.

21. The system of claim 20, further comprising:
a storage device including a database to store experience information associated with each of a plurality of operators associated with a corresponding one of the plurality of workstations; and
wherein the processor of the ACD selects the one of the plurality of workstations based on the experience information associated with the plurality of operators, wherein the session includes a full-duplex audio voice session.

22. The system of claim 16, wherein the processor of the network device is configured to establish a second session between the workstation and the first user device, wherein the second session includes a unidirectional video session from the workstation to the first user device.

23. The system of claim 22, wherein the second session includes a unidirectional audio voice session from the workstation to the first user device.

24. The system of claim 16, wherein the workstation includes a first workstation and wherein the transceiver is further configured to receive from the first workstation, one or more session control protocol messages to establish a third session between a second workstation and the second user device, wherein the one or more session control protocol messages include information indicating the context information and additional context information for establishing the third session.

25. The system of claim 24, wherein a plurality of workstations includes the first workstation and the second workstation, wherein the context information or the additional context information includes a count of the number of sessions established between any of the plurality of workstations and the second user device.
